(19) United States
(12) Patent Application Publication
(10) Pub. No.: US 2011/0087520 A1
(43) Pub. Date: Apr. 14, 2011

(54) SYSTEMS, METHODS, AND COMPUTER-READABLE STORAGE MEDIA FOR VALUING AN EXISTING OR PROSPECTIVE CUSTOMER BASED ON NORMALIZED AND WEIGHTED MEASURES OR ATTRIBUTES

(76) Inventor: Damon Randolph Race, Holly Springs, NC (US)

(21) Appl. No.: 12/888,996

(22) Filed: Sep. 23, 2010

Related U.S. Application Data
(60) Provisional application No. 61/250,627, filed on Oct. 12, 2009.

(51) Int. Cl. G06Q 10/00

(52) U.S. Cl. 705/7.29

(57) ABSTRACT

Systems, methods, and computer-readable storage media for valuing an existing or prospective customer based on normalized and weighted measures or attributes are disclosed. A method in accordance with an embodiment of the presently disclosed subject matter includes determining a plurality of valuation characteristics. The method can also include assigning different weights to the valuation characteristics. Further, the method can include normalizing magnitudes of the valuation characteristics for a plurality of customers. The method can also include applying the weights to the normalized magnitudes of each customer, and summing the results of applying the weights to provide a valuation sum for each customer.

### CROSS REFERENCE TO RELATED APPLICATION

This application claims the benefit of U.S. provisional patent application No. 61/250,627, filed Oct. 12, 2009, the content of which is incorporated herein in its entirety.

### TECHNICAL FIELD

The presently disclosed subject matter relates to marketing and sales. Particularly, the presently disclosed subject matter relates to systems, methods, and computer-readable storage media for valuing an existing or prospective customer based on normalized and weighted measures or attributes.

### BACKGROUND

In many industries prospective customers are valued using multiple measures of differing magnitudes. As an example, in the pharmaceutical industry health care practitioners are often valued on the quantity of prescriptions they write for products in a defined market and other factors such as responsiveness to promotion. Although prescription volume is a consistent measure, the volume of individual prescription products may vary significantly in magnitude. Responsiveness to promotion is a different measure and also differs in magnitude. The challenge is how to value customers across multiple measures of differing magnitudes in a way that truly reflects the business objectives of the company, without the valuation being skewed by differences in magnitude among and or between measures. Accordingly, for at least these reasons, it is desirable to provide improved techniques for valuing prospective customers, particularly health care practitioners.

### SUMMARY

Systems, methods, and computer-readable storage media for valuing an existing or prospective customer based on normalized and weighted measures or attributes are disclosed. According to one embodiment, the first step in a method includes valuing customers is to determine the measures or attributes to be included in the valuation and assign a percentage weight to each category of measure and ultimately to each individual measure. The second step is to normalize the magnitudes of the measures themselves by defining a reachable pool of prospective customers, determine the average for each measure within the pool and then determine each individual's percent of the average. This step eliminates differences in magnitude among the measures that can skew the valuation. The third step is to apply the percentage weights from step one to each individual customer's normalized potential determined in step two and sum the results into one total measurement of customer potential. The most valuable customers may be selected from the pool on the basis of their total measure of potential. Prescriptions associated with managed care data can also be indexed in this fashion according to the volume of prescriptions dispensed under a particular formulary status, tier, co-payment or co-payment band.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIG. 1 is a flow chart of an exemplary method for valuing an existing or prospective customer based on normalized or weighted measures or attributes according to an embodiment of the subject matter disclosed herein; and

FIG. 2 illustrates an exemplary environment for implementing various aspects of the subject matter disclosed herein.

### DETAILED DESCRIPTION

The presently disclosed subject matter is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

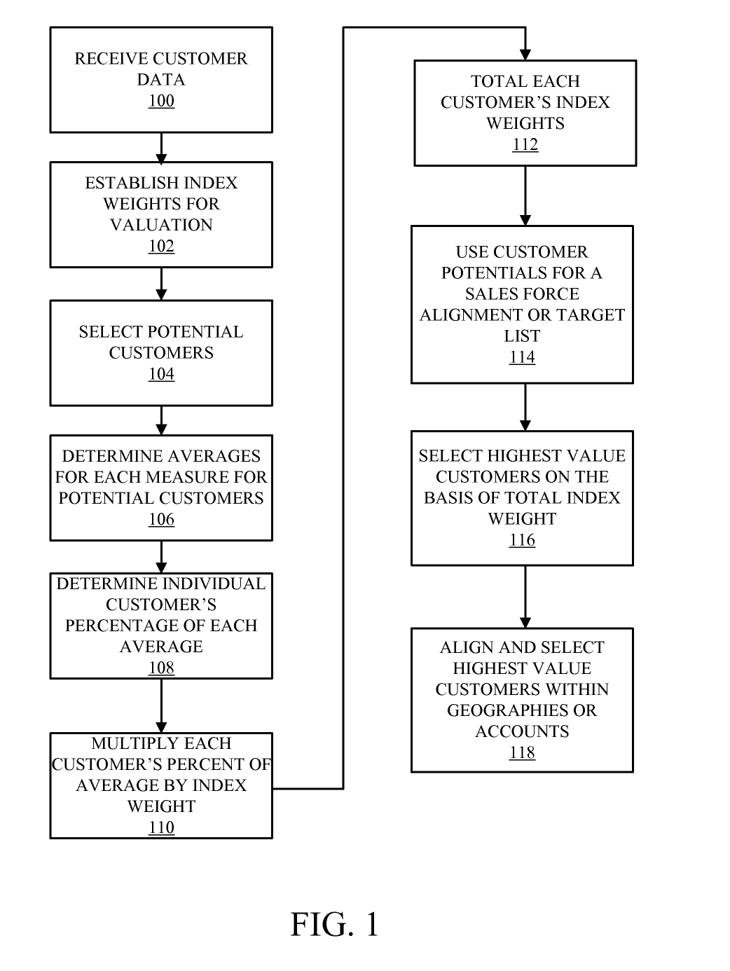

FIG. 1 illustrates a flow chart of an exemplary method for valuing an existing or prospective customer based on normalized or weighted measures or attributes according to an embodiment of the subject matter disclosed herein. The steps of the method may be implemented by a suitable specialized computing device as described in more detail herein. Referring to FIG. 1, at step 100, customer data may be received. Exemplary customer data may include, but is not limited to, practitioner level prescription data, ex-factory sales, order history, outlet level institutional data, patient level longitudinal data associated with practitioners, practitioner level prescription data at the payer, plan or benefit design level. The customer data may be entered into a computing device via user input, computer-to-computer transfer, or any other suitable means for communicating data to a computing device as will be understood by those of skill in the art.

At step 102 of FIG. 1, index weights for evaluation may be established. This index is reflective of business objectives. Table 1 below shows an exemplary valuation index of customer potential.

TABLE 1

| | Measure | | Attribute | Total Index |
|---|---|---|---|---|
| Measures | Weight | Attributes | Weight | Weight |
| Product Usage: | 60% | Product 1 | 30% | 18% |
| | | Product 2 | 70% | 42% |
| Response to | 40% | Campaign A | 60% | 24% |
| Targeted | | Purchase Value | | |
| Advertisements | | Campaign B | 40% | 16% |
| | | Purchase Value | | |
| | 100% | | | 100% |

Examples of product usage may include, but are not limited to, specific pharmaceutical products prescribed by a practitioner, specific products ordered from a company by a customer, reported product usage by a customer in response to a primary market research survey, etc. Product usage could range from prescription medications to consumer products to durable goods orders.

At step 104 of FIG. 1, potential customers are selected. For example, a user may select several customers from a list stored in a computer database. At step 106 of FIG. 1, averages for each measure for potential customers may be determined. Next, individual customer's percentage of each average may be determined (step 108). For example, Table 2 shows a methodology of normalizing measures of differing magnitudes using a percent of average potential. Averages for each measure are determined for the pool of prospective customers and each individual customer's percent of average is determined.

TABLE 2

| | Product 1 | Product 2 | Campaign A | Campaign B |
|---|---|---|---|---|
| Totals for | 50,000 | 120,000 | $60,000 | $80,000 |
| Customer Pool | | | | |
| Number of | 3,000 | 3,000 | 3,000 | 3,000 |
| Customers | | | | |
| Average | 17 | 40 | $20 | $27 |
| Individual | 22 | 46 | $21 | $25 |
| Customer A | | | | |
| Percent of | 1.32 | 1.15 | 1.05 | 0.94 |
| Average | | | | |

Customer Pool may be defined as the sum total product usage, total order volume or total sales of a particular product or item by the group of customers included in the pool. The party performing the valuation of the customers should only select customers to be included in the customer pool that the party believes they can reasonably impact or reach in their targeting, marketing or sales efforts.

At step 110 of FIG. 1, each customer's percent of average may be multiplied by index weight. Each customer's index weights may be totaled (step 112). For example, Table 3 shows a methodology of multiplying a customer's percent of the average customer's value by the Index weights, and summing the results into a Total Index Value of potential.

TABLE 3

| | Product 1 | Product 2 | Campaign A | Campaign B |
|---|---|---|---|---|
| Individual | 22 | 46 | $21 | $25 |
| Customer A | | | | |
| Percent of Average | 1.32 | 1.15 | 1.05 | 0.94 |
| Index Weights | 18% | 42% | 24% | 16% |
| Index | 0.24 | 0.48 | 0.25 | 0.15 |
| Total Index Value | | | | 1.12 |

An individual customer may represent a company, consumer, customer, health practitioner or any other entity that may use or buy products. Percent of Average may be the result of division of an individual customer's product usage by the product usage of the average customer included in the Customer Pool. Index weights may be added to 100% and may be allocated to reflect the importance that the party conducting the valuation exercise places on the individual attributes being valued. Index is the result of multiplying the Index Weight and the Percent of Average for the individual attribute.

At step 114 of FIG. 1, the customer potentials are used for sales force alignment or target list. The highest value customers may be selected on the basis of total index weight (step 116). The highest value customers may be aligned and selected within geographies or accounts. This technique provides a beneficial methodology for valuing prospective customers, particularly health care practitioners.

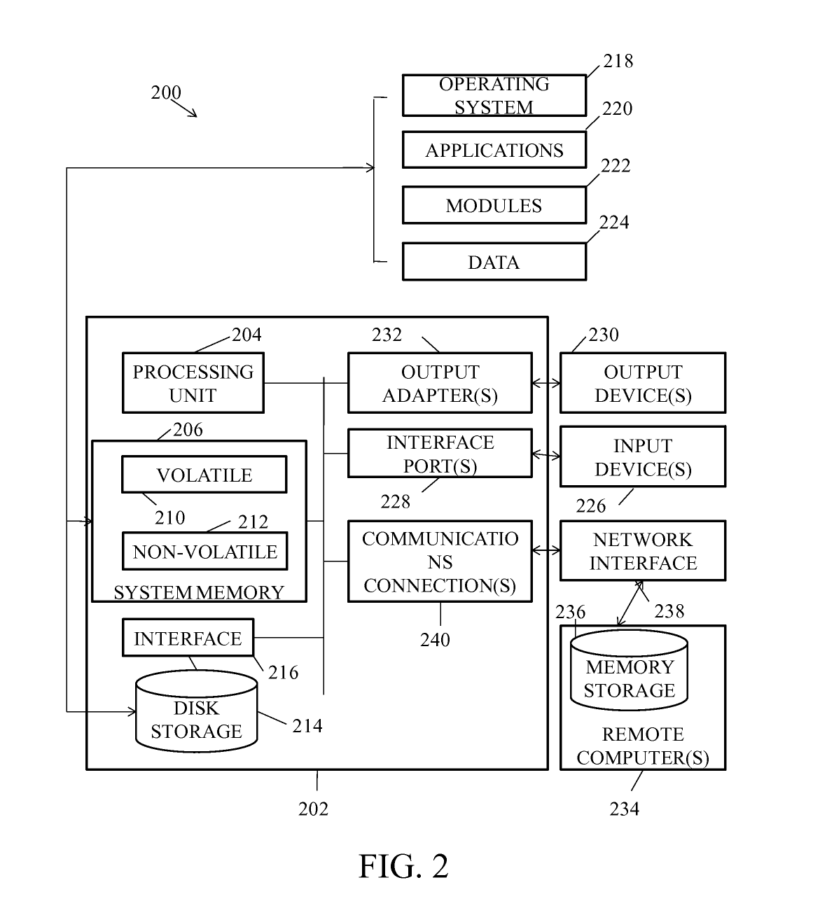

The subject matter disclosed herein may be implemented by a suitable computing device comprising at least a processor and memory. In an example, a customer analyzer function implemented by the operating environment shown in FIG. 2. Referring to FIG. 2, the following discussion are intended to provide a brief, general description of a suitable operating environment 200 in which various aspects of the disclosed subject matter may be implemented. While the presently disclosed subject matter is described in the general context of computer-executable instructions, such as program modules, executed by one or more computers or other devices, those skilled in the art will recognize that the disclosed subject matter can also be implemented in combination with other program modules and/or as a combination of hardware and software.

Generally, however, program modules include routines, programs, objects, components, data structures, etc. that perform particular tasks or implement particular data types. The operating environment 200 is only one example of a suitable operating environment and is not intended to suggest any limitation as to the scope of use or functionality of the subject matter disclosed herein. Other well known computer systems, environments, and/or configurations that may be suitable for use with the presently disclosed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 2, an exemplary environment 200 for implementing various aspects of the subject matter disclosed herein includes a computer 202. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 206 includes volatile memory 210 and nonvolatile memory 212. The basic input/output system (BIOS), containing the basic routines to transfer information between elements within the computer 202, such as during start-up, is stored in nonvolatile memory 212. By way of illustration, and not limitation, nonvolatile memory 212 can include read only memory (ROM), programmable ROM (PROM), electrically programmable ROM (EPROM), electrically erasable ROM (EEPROM), or flash memory. Volatile memory 210 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 202 also includes removable/nonremovable, volatile/nonvolatile computer storage media. FIG. 2 illustrates, for example, disk storage 214. Disk storage 214 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 214 to the system bus 208, a removable or non-removable interface is typically used such as interface 216.

It is to be appreciated that FIG. 2 describes software that acts as an intermediary between users and the basic computer resources described in suitable operating environment 1900. Such software includes an operating system 218. Operating system 218, which can be stored on disk storage 214, acts to control and allocate resources of the computer system 202. System applications 220 take advantage of the management of resources by operating system 218 through program modules 222 and program data 224 stored either in system memory 1906 or on disk storage 214. It is to be appreciated that the subject matter disclosed herein can be implemented with various operating systems or combinations of operating systems.

A user enters commands or information into the computer 202 through input device(s) 226. Input devices 226 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 204 through the system bus 208 via interface port(s) 228. Interface port(s) 228 include, for example, a serial port, a parallel port, a game port, and a universal serial bus (USB). Output device(s) 230 use some of the same type of ports as input device(s) 226. Thus, for example, a USB port may be used to provide input to computer 202 and to output information from computer 202 to an output device 230. Output adapter 232 is provided to illustrate that there are some output devices 230 like monitors, speakers, and printers among other output devices 230 that require special adapters. The output adapters 1932 include, by way of illustration and not limitation, video and sound cards that provide a means of connection between the output device 230 and the system bus 208. It should be noted that other devices and/or systems of devices provide both input and output capabilities such as remote computer(s) 234.

Computer 202 can operate in a networked environment using logical connections to one or more remote computers, such as remote computer(s) 234. The remote computer(s) 234 can be a personal computer, a server, a router, a network PC, a workstation, a microprocessor based appliance, a peer device or other common network node and the like, and typically includes many or all of the elements described relative to computer 202. For purposes of brevity, only a memory storage device 236 is illustrated with remote computer(s) 234. Remote computer(s) 234 is logically connected to computer 202 through a network interface 238 and then physically connected via communication connection 240. Network interface 238 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware/software employed to connect the network interface 238 to the bus 208. While communication connection 240 is shown for illustrative clarity inside computer 202, it can also be external to computer 202. The hardware/software necessary for connection to the network interface 238 includes, for exemplary purposes only, internal and external technologies such as, modems including regular telephone grade modems, cable modems and DSL modems, ISDN adapters, and Ethernet cards.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A computer implemented method for valuing a customer, the method comprising:
determining a plurality of valuation characteristics;
assigning different weights to the valuation characteristics;
normalizing magnitudes of the valuation characteristics for a plurality of customers;
applying the weights to the normalized magnitudes of each customer; and
summing results of applying the weights to provide a valuation sum for each customer.

2. The computer implemented method of claim 1, wherein the valuation characteristics comprise at least one of valuation measures and valuation attributes.

3. The computer implemented method of claim 1, further comprising:
determining an average for each measure; and
determining a percent of the average for each customer.

4. The computer implemented method of claim 3, wherein the user input device comprises one of a keyboard, mouse, and touchpad.

5. The computer implemented method of claim 1, further comprising providing a user output device for presenting the valuation sum for each customer to a user.

6. The computer implemented method of claim 5, wherein the user output device comprises a display.

7. The computer implemented method of claim 1, wherein the valuation of customers is used at least partially for performing one of geographic-based and account-based sales force alignments.

8. A system for valuing a customer, the system comprising:
a memory having stored therein computer-executable instructions;
a computer processor that executes the computer-executable instructions;
a customer analyzer configured to:
determine a plurality of valuation characteristics;
assign different weights to the valuation characteristics;
normalize magnitudes of the valuation characteristics for a plurality of customers;
apply the weights to the normalized magnitudes of each customer; and
sum results of applying the weights to provide a valuation sum for each customer.

9. The system of claim 8, wherein the valuation characteristics comprise at least one of valuation measures and valuation attributes.

10. The system of claim 8, wherein the customer analyzer is configured to:
determine an average for each measure; and
determine a percent of the average for each customer.

11. The system of claim 8, further comprising a user output device configured to present the valuation sum for each customer to a user.

12. The system of claim 11, wherein the user output device is a display.

13. The system of claim 8, wherein the valuation of potential or existing customers is used in whole or in part for performing geographic-based or account-based sales force alignments.

14. A computer-readable storage medium having a tangible physical structure, the medium having stored thereon computer-readable instructions for valuing a customer by performing the steps of:
determining a plurality of valuation measures or attributes;
assigning different weights to the valuation measures or attributes;
normalizing magnitudes of the valuation measures or attributes for a plurality of prospective or existing customers; and
applying the weights to each customer's normalized potential and summing the results into a valuation sum for each customer.

15. The computer-readable storage medium of claim 14, wherein the valuation characteristics comprise at least one of valuation measures and valuation attributes.

16. The computer-readable storage medium of claim 14, wherein the computer-readable instructions comprise:
determining an average for each measure; and
determining a percent of the average for each customer.

17. The computer-readable storage medium of claim 14, computer-readable instructions comprise using a user output device for presenting the valuation sum for each customer to a user.

18. The computer-readable storage medium of claim 17, wherein the user output device comprises a display.

19. The computer-readable storage medium of claim 14, wherein the valuation of customers is used at least partially for performing one of geographic-based and account-based sales force alignments.
